(19) United States
(12) Patent Application Publication
(10) Pub. No.: US 2019/0036235 A1
(43) Pub. Date: Jan. 31, 2019

(54) ELECTRICAL CONNECTOR AND TERMINAL FOR A WINDING OF CAPILLARY WIRE OF AN IGNITION COIL FOR INTERNAL COMBUSTION ENGINES, IGNITION COIL FOR INTERNAL COMBUSTION ENGINES AND FITTING PROCESS FOR THE ENGAGEMENT OF SAID CONNECTOR

(71) Applicants: ELDOR CORPORATION S.P.A., Orsenigo (Como) (IT); TYCO ELECTRONICS AMP ITALIA S.R.L., Collegno (Torino) (IT)

(72) Inventors: Marco BARBERIS, Collegno (Torino) (IT); Marcello FARINOLA, Collegno (Torino) (IT); Alessandro GENTA, Collegno (Torino) (IT); Dorian BISETTI, Collegno (Torino) (IT); Mauro GALIMBERTI, Orsenigo (Como) (IT); Pasquale FORTE, Orsenigo (Como) (IT)

(73) Assignees: Eldor Corporation S.P.A., Orsenigo (Como) (IT); Tyco Electronics Amp Italia S.R.L., Collegno (Torino) (IT)

(21) Appl. No.: 16/069,807

(22) PCT Filed: Jan. 16, 2017
(86) PCT No.: PCT/IB2017/050221

§ 371 Date: Jul. 12, 2018

(30) Foreign Application Priority Data
Jan. 14, 2016 (IT) 102016000002972

(51) Int. Cl. H01R 4/2433; H01R 4/48; H01R 43/027

(52) U.S. Cl. CPC H01R 4/2433; H01R 2201/26; H01R 43/027; H01R 4/48

(57) ABSTRACT

An ignition coil for an ignition system of an internal combustion engine includes a primary winding connected, by an electrical connection, to a generator, and a secondary winding connected to a spark plug and including a plurality of turns of capillary wire covered with an insulating layer and wound on an electrically insulating support. The support includes a receiving seat in which there is inserted a terminal to which an end portion of the capillary wire is anchored. A connector includes an elastic clip contact element that is fitted on the terminal and is provided with a cutting element to cut the insulating layer of the capillary wire. A stop device prevents the elastic clip contact element from closing beyond a determined amount or entity. An abutment body abuts on the terminal to establish the electrical connection between the capillary wire and the terminal.

### FIELD OF THE INVENTION

The present invention refers to an electrical connector and a terminal for a winding of capillary wire in an ignition coil for internal combustion engines, to an ignition coil for internal combustion engines and to a fitting process for the engagement of said electrical connector in said terminal.

The present invention applies primarily to the automotive sector, and in particular to the production and assembly of the secondary winding of an ignition coil for internal combustion engines, that is to say, to the production of components generally known as ignition coils.

### DISCUSSION OF THE PRIOR ART

As is known, ignition coils consist of transformers comprising two concentric conductive windings, of varying number and size, usually known as the “primary” winding and “secondary” winding, in which the primary winding is connected by means of an electrical connection, to the voltage generator and the secondary winding is instead connected to the spark plug.

In particular, as far as the secondary winding is concerned, the wire that forms the winding is connected to the respective terminations by welding the ends of the wire to an appropriately shaped portion of said terminations.

The need to provide a welded connection is mainly due to the reduced size of the wire, also referred to as “capillary wire”, which has a conductor diameter of less than 0.10 mm (for example 0.056 mm).

As a result of this reduced size, the insulating layer covering the wire has an even smaller thickness and its removal using mechanical means (i.e., peeling/scraping) can irreparably undermine the integrity of the conductor wire, and thus the quality of the electrical connection.

Welding overcomes this problem, but has disadvantages in terms of the quality, cleanliness and even the reliability of the end product.

### Purpose of the Invention

In light of the above, the purpose of the present invention is to provide an electrical connection, a terminal, an ignition coil for internal combustion engines and a fitting process for the engagement of said connector in said terminal which overcome the drawbacks of the prior art described above. In particular, the purpose of the present invention is to provide an electrical connector and a terminal having a relatively simple structure and which are economical, but which can also be used in the most demanding applications.

Moreover, a further purpose of the present invention is to provide an ignition coil for high-performance internal combustion engines, with reduced faultiness and, at the same time, that can be produced at low cost.

Another purpose of the present invention is to conceive a simple and reliable process for inserting an electrical connector in a terminal of an ignition coil for internal combustion engines.

In order to achieve these and further purposes, the object of the invention is a connector for connection to an ignition coil in an ignition system of an internal combustion engine comprising a terminal on which is wound an end portion of a capillary wire covered by an insulating layer; the connector comprising an elastic clip contact element of conductive material which can be fitted on said terminal and which is movable between an open position and a closed position, said elastic clip contact element in a rest condition tending to return to the closed position; the elastic clip contact element ( ) is provided with

at least one cutting element on at least one inner wall for cutting the insulating layer of the capillary wire wound on the terminal and

stop means which prevent the elastic clip contact element from closing beyond a determined amount.

It is worth noting that, in the closed position, the elastic clip contact element performs a mechanical retention function while at the same time establishing an electrical contact between the terminal and the capillary wire of the magnetic coil.

Operatively, before being inserted in the terminal, the connector is maintained in the open position either manually or with the aid of a specific tool that moves the elastic clip contact element into the open position and keeps it open until the end of the insertion, so as to prevent the cutting elements from coming into contact with the wire wound on the terminal during the insertion.

Preferably, the elastic clip contact element is obtained by cutting and bending a metal sheet.

Said at least one cutting element is, instead, produced by means of deformation or milling or broaching.

Alternatively, it could be obtained by means of milling or plastic deformation of the material (that is, by means of die forming).

Structurally, the elastic clip contact element preferably comprises a joining wall from which two retaining tabs extend transversally and are provided, respectively, with a first and a second inner face facing each other. At least one cutting element is formed on said first inner face.

The conformation of said retaining tabs is such as to allow preloading of said tabs in order to ensure the closing of the elastic clip contact element on the terminal.

In that respect, the retaining tabs preferably extend at least partly towards each other and have, respectively, the first and the second inner face facing each other.

Said inner faces thus define the portion that comes into contact with said terminal (i.e., the portion that establishes the electrical contact).

Preferably, the stop means of the elastic clip contact element are defined by at least a first projecting portion and a second projecting portion of the first and second inner face of the retaining tabs.

The first projecting portion protrudes more from the respective inner face (the first) than said cutting element.

Thus, when the first projecting portion is placed in contact with the terminal, the cutting element is at a distance from it so as not to cut the wire.

The second projecting portion instead comprises at least one bulge 8 projecting from the second inner face and placed in contact with the protrusion of the terminal to establish the electrical connection.

Said bulge defines an abutment body of the connector designed to establish the electrical contact with the terminal.

The second inner face further comprises a seat, adjacent to said bulge, facing the cutting element. Said seat is sized to accommodate, without damaging them, those return portions of the capillary wire turns cut, on said first planar face of the protrusion, by the cutting element.

In other words, in an assembled configuration of the coil, the capillary wire is wound on the terminal with a plurality of adjacent turns arranged side by side and exposed on at least two sides/faces of said terminal and the connector is inserted in the terminal so that the first inner face is facing one side and the second inner face is facing the other side; in this way:
the cutting element penetrates the insulation layer of the portion of turns visible on the respective side of the terminal;
the bulge comes into contact with the terminal on the opposite side with respect to the cutting element;
the receiving seat accommodates the portion of turns visible on such opposite side.

The object of the present invention is also a terminal for a capillary wire winding of an ignition coil for internal combustion engines.

Said terminal comprises a base that can be plugged into a capillary wire winding support and a protrusion extending away from the base.

According to one aspect of the present invention, the protrusion is provided with at least a first, ligature, area, designed to allow the fixation of the capillary wire, and a second, contact, area, designed to receive a plurality of adjacent turns of said capillary wire.

Preferably the first area is distal to the base with respect to the second area.

It is also worth noting that the protrusion preferably comprises a third area, separate from the other two and designed to accommodate the contact of the contact body (i.e., bulge) described previously. Thus, in use, the bulge of the connector described previously rests on said intermediate area.

Preferably, the third area is interposed between the first and the second.

According to one aspect of the present invention, the protrusion of the terminal is substantially flat.

Thus, said protrusion has at least a first and a second planar face opposite one another and connected by means of two lateral flanks, wherein said second area is defined on said first planar face.

Preferably, the protrusion has at least a first transverse groove formed in one of its lateral flanks and delimiting at least part of the first area.

In particular, said groove is delimited by two ramps opposite one another and spaced apart, defining respective shoulders for holding the capillary wire.

Moreover, the protrusion has at least a second transverse groove formed in one of its lateral flanks and delimiting at least part of the second area (longitudinally).

According to further optional aspects of the present invention, the base of the terminal also has some specific features.

Preferably, the base has an edge extending laterally to said protrusion and provided with at least a top face extending in a plane transverse to a main direction of extension of the protrusion to define a support surface for a connection portion of the capillary wire extending from said second area.

Therefore, once assembled, the capillary wire is wound and tied to the first area (ligature), it continues towards the base wound with a series of turns parallel to the second area (contact) and extends away from the protrusion resting on the support surface.

The reverse is also possible: the capillary wire runs resting on the support surface, continues towards the base wound so as to form the series of parallel turns in the second area (contact) and then ends its path tied in the first area (ligature).

The purposes of the present invention are also achieved with a coil for an ignition system of an internal combustion engine, comprising a primary winding that can be connected (by means of an electrical connection) to a generator, a secondary winding that can be connected to a spark plug and provided with a multitude of turns of capillary wire covered with an insulating layer and wound on an electrically insulating support, wherein the support comprises at least one receiving seat in which there is inserted a terminal on which said capillary wire is wound.

According to one aspect of the present invention, the coil comprises a connector provided with an elastic clip contact element fitted on said terminal and provided with:
at least one cutting element for cutting said insulating layer;
stop means that abut on said terminal to prevent the elastic clip contact element from closing beyond a determined amount (i.e., measure);
an abutment body to establish the electrical connection between said capillary wire and said terminal.

Preferably, the terminal is of the type described above.

Thus, said terminal comprises a base coupled to the support and a protrusion to which the capillary wire is fixed without welding and wound to define a plurality of successive turns.

The protrusion is preferably flat, and thus defined by two planar faces opposite one another.

The connector is also preferably of the type described above.

Thus, the elastic clip contact element is provided with a pair of retaining tabs having a first and a second inner face opposite one another, wherein the first inner face comprises said at least one cutting element and the second inner face comprises said bulge.

Therefore, the elastic clip contact element is fitted on the protrusion of the terminal and arranged in the closed position so that:
the cutting element penetrates the insulating layer of the turns of capillary wire facing one side (or face) of the protrusion;
the bulge comes into contact with the other side (or face) of the protrusion.

### BRIEF DESCRIPTION OF THE DRAWINGS

Further characteristics and advantages of the invention will become clear from the following description with reference to the accompanying drawings, provided merely by way of non-limiting example, in which:

FIGS. 1 to 3 are exploded schematic views of different details of an ignition coil for an ignition system for internal combustion engines according to the present invention;

FIGS. 4 to 6 show a plan view and two front views of a terminal according to the present invention;

FIG. 6 shows a cross sectional view of an electrical connector according to the present invention in a configuration in which it is assembled on the terminal in FIG. 4;

FIG. 7 is a perspective view of the connector in FIG. 6;

FIG. 8 is a perspective view of a component of the connector in FIG. 7;

FIG. 9 shows the component of FIG. 8 open in two semi-parts;

FIGS. 10 to 15 schematically illustrate a process for inserting the connector in FIG. 6 in the terminal in FIG. 4, according to the present invention.

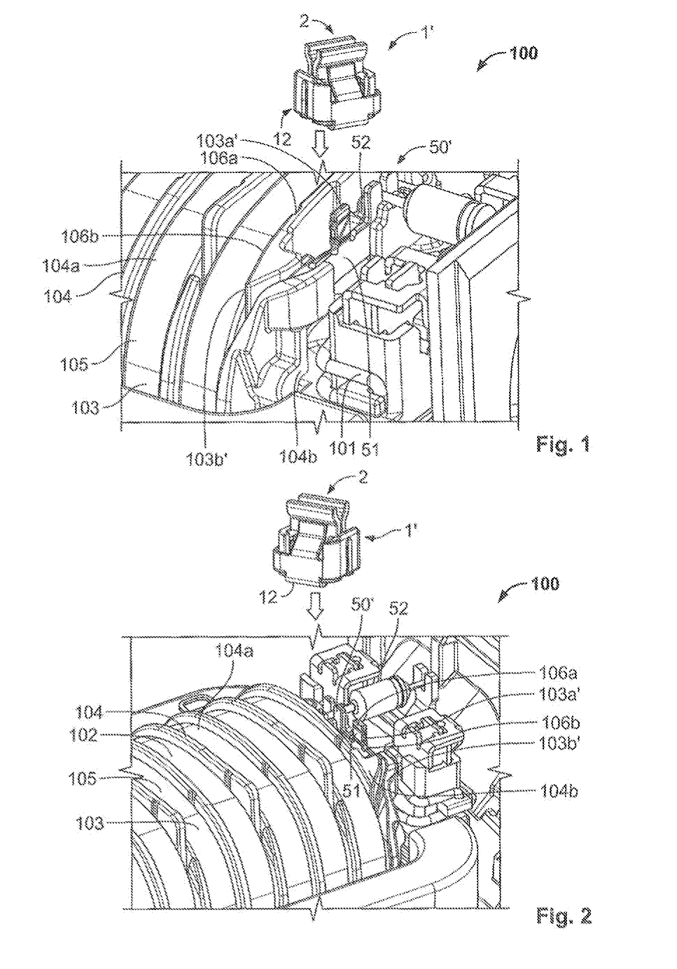

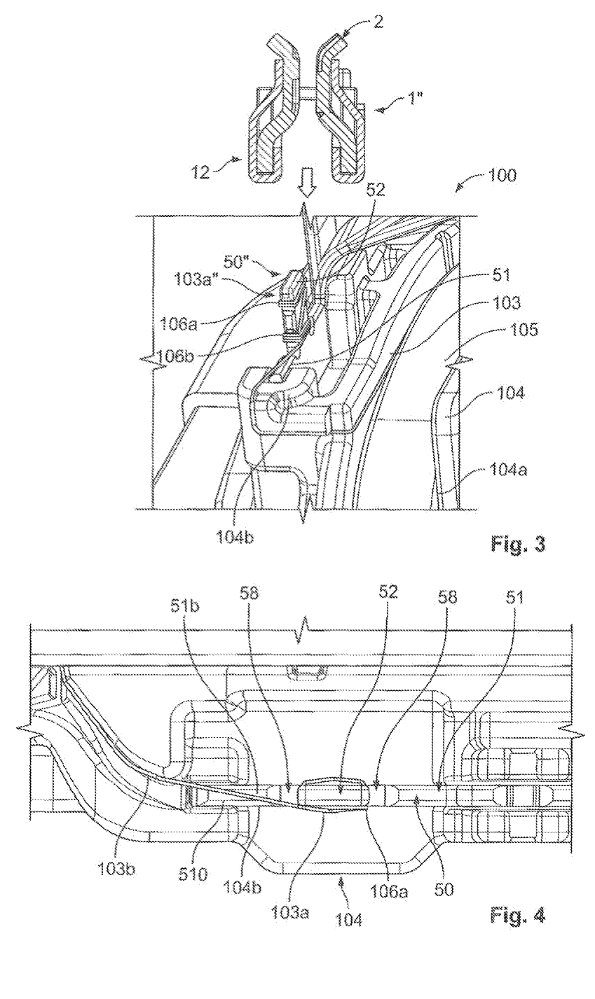

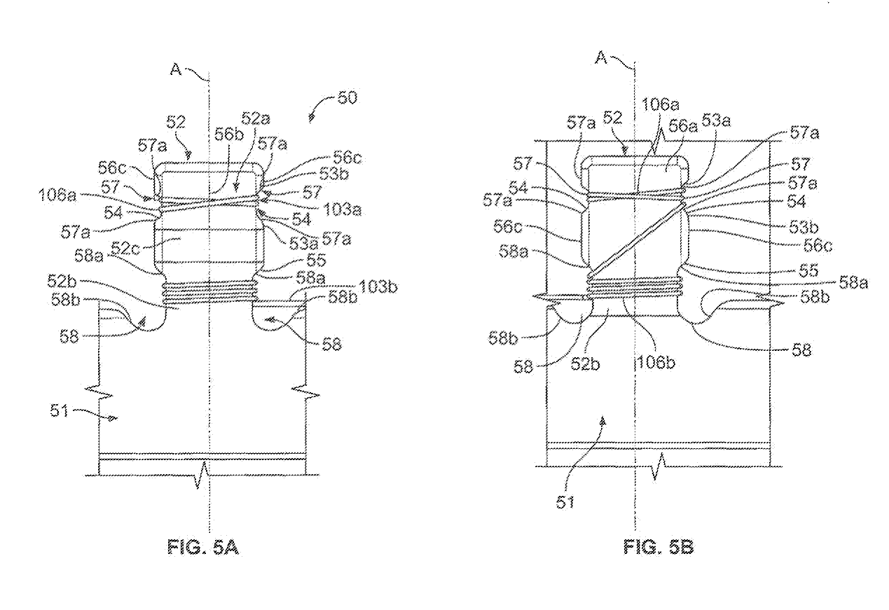

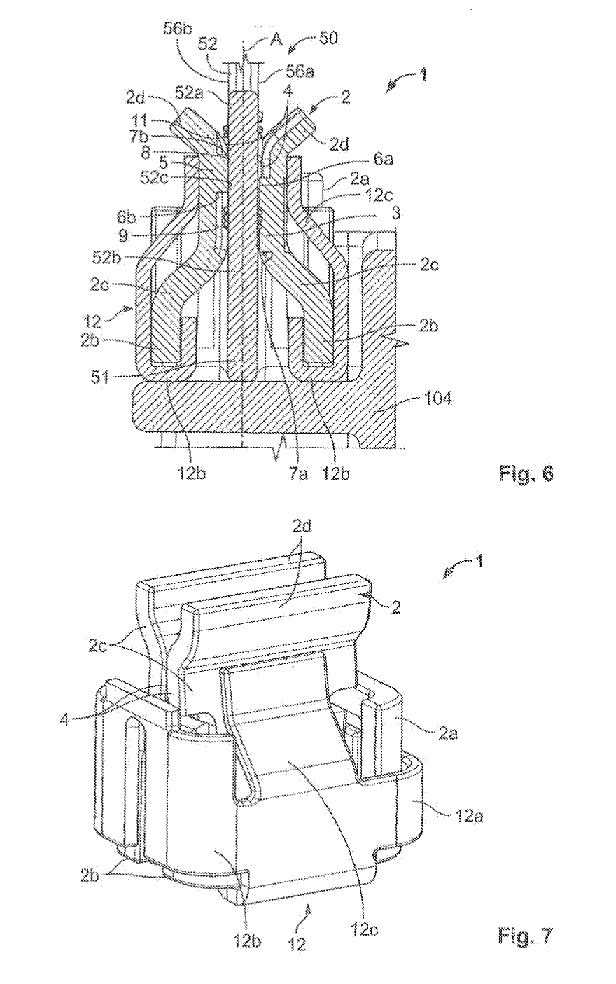

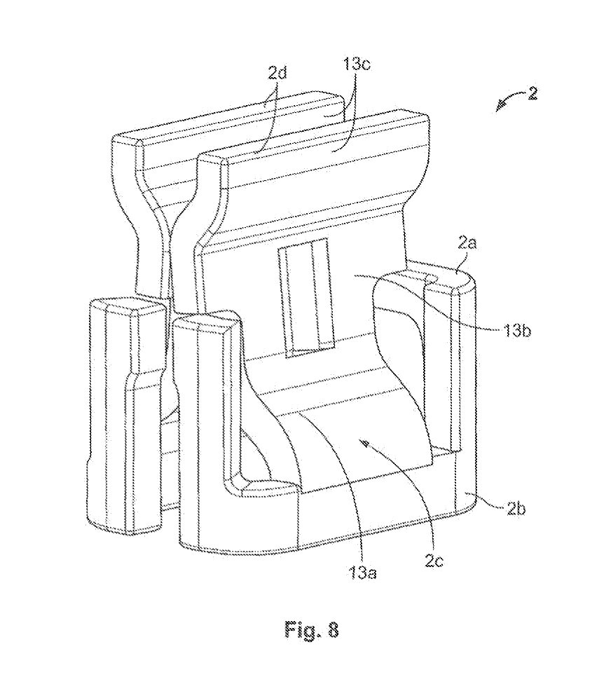

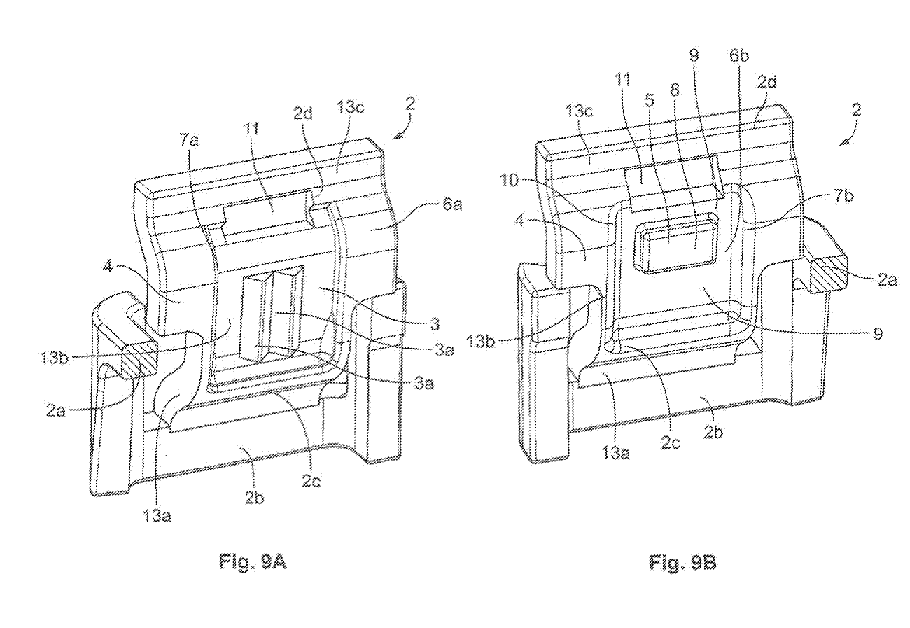

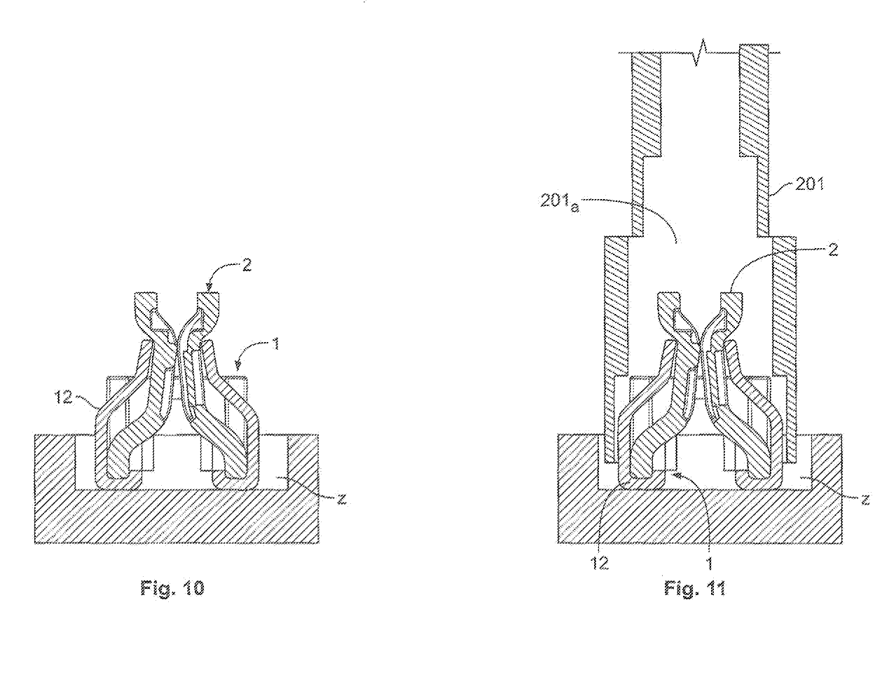

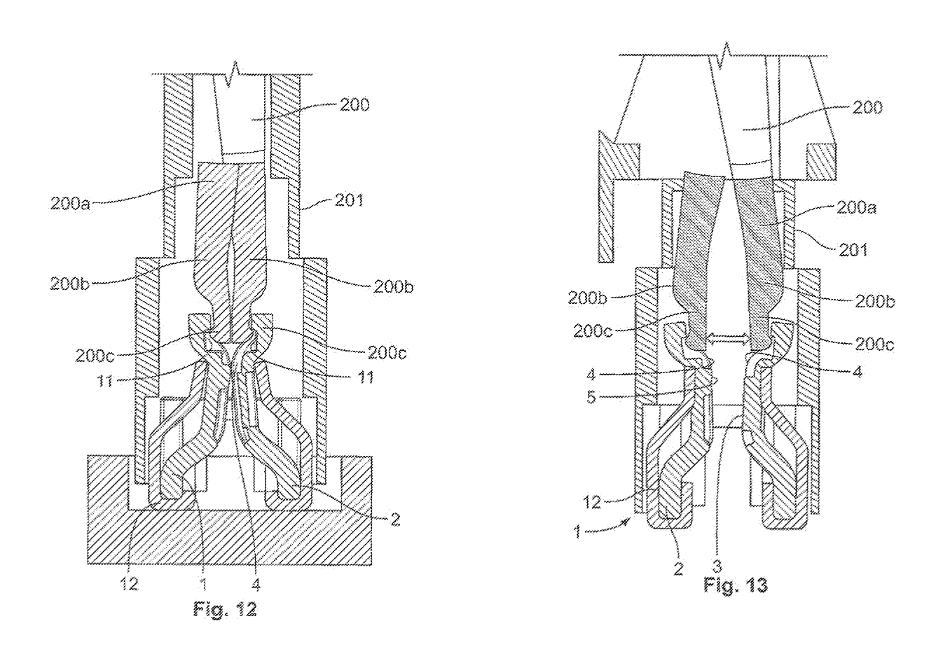

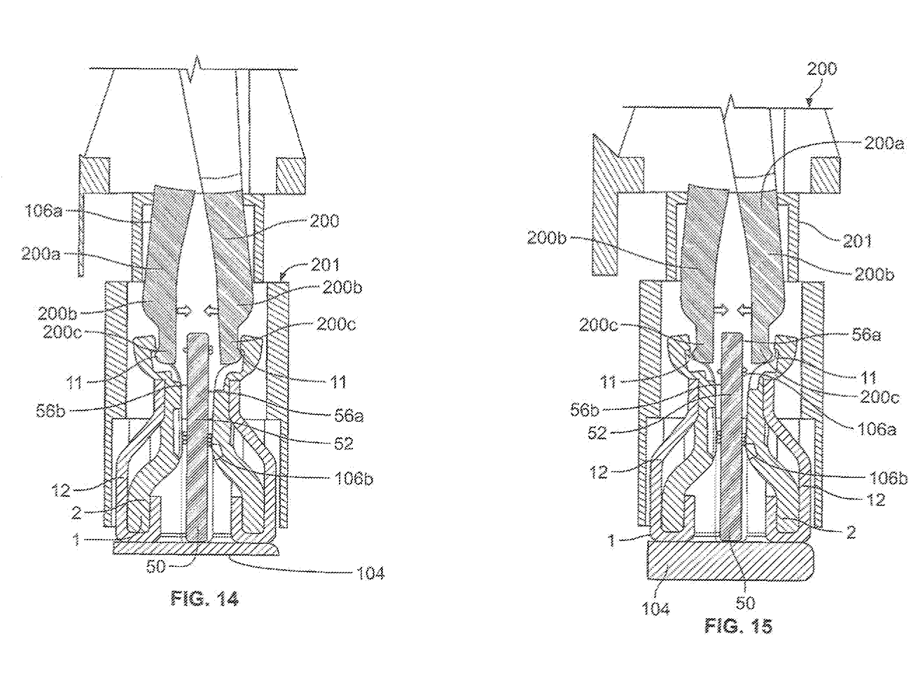

### DETAILED DESCRIPTION OF PREFERRED EMBODIMENTS OF THE INVENTION

A more detailed understanding of the embodiments disclosed herein may be gained from the following description in which various specific details are explained. The embodiments may be implemented without one or more of the specific details, or using other methods, components, materials, etc. In other cases, the structures, construction details, materials or operations known in the prior art are not illustrated or described in detail, in that they may be implemented in any known way and also in that they do not, in themselves, fall within the scope of protection of the present invention.

With reference to the accompanying Figures, number 100 indicates an ignition coil 100 for an ignition system of an internal combustion engine.

The coil 100 comprises a primary winding 101, which can be connected by means of an electrical connection to a generator, and a secondary winding 102, which can be connected to a spark plug (not illustrated).

The secondary winding 102 is implemented by means of a capillary wire 103 covered with an insulating layer and wound on an electrically insulated support 104 so as to define a multitude of turns 105.

It is worth noting that in the context of the present application, the term “capillary wire” is used to describe and claim a wire having a conductive core and outer insulation, the overall diameter/thickness of the cross section of which is less than 0.5 mm, preferably less than 0.1 mm.

The support 104, preferably made of plastic material, comprises an annular winding portion 104a, on which the turns 105 are wound, and at least one receiving seat 104b in which a terminal 50 is inserted. An end portion 103a of the capillary wire 103 is wound on the terminal 50.

Preferably, the receiving seat 104b of the support 104 comprises a cavity having a conformation that is substantially counter-shaped with respect to a profile of the terminal 50. More preferably, the terminal 50 is inserted by interference in the cavity.

Thus, the cavity is preferably provided with a plurality of friction protrusions 104c designed to hold the terminal 50 in place.

However, alternatively, the terminal 50 may be provided with friction protrusions or ribs.

It is worth noting that the coil 100 preferably comprises two terminals 50 on which respective end portions 103a of the capillary wire 103 are wound.

Thus, the capillary wire 103 of the secondary winding 102 has a first and a second end portion 103a, each connected to a respective first or second terminal 50 and a respective first or second connector 1.

A first terminal 50 is electrically connected to the spark plug, whereas a second terminal 50 is electrically connected to a mass (i.e., ground).

It is worth noting that, according to one aspect of the present invention, the capillary wire 103, in particular an end portion 103a thereof, is wound on (and fixed to) said terminal 50 (or each terminal 50) without welding.

To establish the connection between the capillary wire 103a (insulated) and each terminal 50, the coil 100 comprises a connector 1 provided with an elastic clip contact element 2, made of an electrically conductive material and fitted on said terminal 50.

In order to establish the contact with the wire, the elastic clip contact element 2 comprises at least one cutting element 3 to cut the insulating layer of the capillary wire 103 wound on the terminal 50.

It is worth noting that, to prevent the cutting element 3 from damaging the wire 103, the connector 1 (in particular the elastic clip contact element 2) is provided with stop means 4 that abut on said terminal 50 to prevent the elastic clip contact element from closing beyond a determined entity (or amount).

In order to establish the contact with the terminal 50, the elastic clip contact element 2 comprises at least one abutment body 5 which abuts on the terminal 50.

Advantageously, in this way the connector 1 permits the establishment of the electrical contact between the capillary wire 103 and the terminal 105 via a simple insertion and without the need for welding.

Moreover, the combined presence of stop means 4 and the abutment body 5 ensures the limited penetration of the wire insulating layer by the cutting element 3 so that the integrity of said wire 103 is not undermined.

Preferably, the terminal 50 comprises a plate of conductive material that is inserted (or can be inserted) in the receiving seat 104a of the support 104.

In the preferred embodiment, the terminal 50 is made of phosphor bronze or brass.

Structurally, the terminal 50 comprises a base 51 that can be plugged into the support 104 of the secondary winding 102.

More precisely, said base is engaged by friction/interference in the receiving seat 104a obtained in the support 104 described above.

Preferably, a protrusion 52 extends away from the base 51.

Said protrusion 52 preferably extends along a main direction “A” thereof transversely to the base 51; said protrusion 52 preferably extends along a main direction “A” substantially orthogonal to a support surface of said terminal 50 in the receiving seat 104a.

Said protrusion 52 is the reference about which a respective end portion 103a of the capillary wire 103 is fixed and on which the connector 1 is fitted as described in more detail below.

As already mentioned, the end portion 103a of the capillary wire 103 is fixed to the protrusion without welding.

Thus, the protrusion 52 is preferably provided with at least a first, ligature, area 52a, configured to permit the anchoring of the capillary wire 103.

Moreover, the protrusion 52 is preferably provided with a second, contact, area 52b, designed to receive a plurality of adjacent turns of said capillary wire 103.

Thus, the end portion 103a of the capillary wire 103 preferably comprises a ligature portion 106a fixed to the first area 52a of the protrusion 52.

Said ligature portion 106a has at least two turns that overlap one another (and/or are knotted together) in order to fix the capillary wire 103 to the terminal 50 without welding.

Preferably, however, in light of the uneven conformation of the ligature portion owing to said overlapping/knotting, the end portion 103a of the capillary wire 103 preferably also comprises a contact portion 106b wound on the second area 52b of the protrusion 52.

Said contact portion 106b is preferably defined by a plurality of adjacent and substantially parallel turns.

Advantageously, the more even extension of the turns in the second area with respect to the first, improves the repeatability of the cutting of the insulating layer and thus achieves better production quality.

It is worth noting that in this context the term “turns” is used to define windings, that is portions wound annularly around the protrusion 52, in particular around the second area 52b.

Preferably, the first area 52a and the second area 52b are arranged in succession along a main direction “A” of the protrusion 52.

Furthermore, more preferably the protrusion also comprises a third area 52c (having at least one face free of capillary wire 103), large enough to permit the abutment of the abutment body 5 of the connector 1 to close the electrical circuit.

Therefore, the second area 52b is a second area between the connector 1 and the capillary wire 103 (where the penetration of the insulating layer occurs), whereas the third area 52c is a second area between the connector 1 and the terminal 50.

Preferably, the third area 52c is interposed between the first area 52a and the second area 52b.

In the preferred embodiment, the first area 52a is distal to the base 51 with respect to the second area 52b.

In other words, the second area 52b is proximal to the base 51 with respect to the first area 52a (and the third area 52c).

Preferably, the first area 52a extends between an end 53a distal to and an end 53b proximal to the second area 52b.

At least the end 53b proximal to the second area 52b is defined by at least one wire retaining shoulder 54 extending transversely to the main direction “A” of the protrusion 52 to prevent the sliding of the capillary wire 103 (in particular the ligature portion 106a) towards the second area 52b.

Likewise, the second area 52b has at least one end proximal to the first area 52a which is also defined by at least one retaining shoulder 55 of the wire 103 extending transversely to the main direction “A” of the protrusion 52 to prevent the sliding of the wire 103 towards the first area 52a.

In the preferred embodiment, the protrusion 52 has a substantially planar conformation.

Advantageously, this makes it possible to define at least a pair of substantially planar surfaces which guarantee and facilitate the establishment of the electrical connection.

In particular, the protrusion 52 comprises at least a first planar face 56a and a second planar face 56b opposite one another and connected by two lateral flanks 56c.

The second area 52b is defined on said first planar face 56a.

The third area 52c is instead preferably defined on the second planar face 56b.

Thus, preferably, as explained in more detail later on, the connector 1 has the cutting element 3 and the abutment body 5 opposite one another and acting on different faces of the protrusion 52.

Preferably, the protrusion 52 has at least a first transverse groove 57 formed in one of its lateral flanks 56c and defining at least part of the first area 52a.

More precisely, the first transverse groove 57 is delimited by two ramps 57a opposite one another and spaced apart, defining the proximal 53a and distal 53b ends of the first area 52a.

Thus, the ramps 57a define respective shoulders 54 for retaining the capillary wire 104.

Preferably, there are two first transverse grooves 57, aligned with one another and defining a narrowing of the cross section of the protrusion 52.

Moreover, again with reference to the embodiment that is illustrated, the protrusion 52 has at least a second transverse groove 58 formed in one of its lateral flanks 56c and defining at least part of the second area 52b.

Preferably, there are two second transverse grooves 58, aligned with one another and defining a narrowing of the cross section of the protrusion 52.

In the preferred embodiment, said second transverse groove 58 is formed in an area of intersection between the protrusion 52 and the base 51.

More precisely, the second transverse groove 58 is delimited by a first edge 58a proximal to the first area 52a and adjacent to the protrusion 52, and by a second edge 58b, distal to the first area 52a and adjacent to the base 51.

Said edges 58a, 58b are oriented transversely, preferably orthogonally, with respect to one another.

Said second edge 58b, in particular, defines a connection between the protrusion 52 and the base 51, preferably with one edge of the base 51.

The base 51 preferably has one edge 51a extending laterally to the protrusion 52, at a transverse angle with respect to the latter.

Preferably, the edge 51a is provided with at least one top face 5ab extending in a plane transverse to the main direction “A” of the protrusion.

Said top face 51b defines a support surface for a portion of capillary wire 103 extending from said second area 52b.

In that respect, it is worth noting that the capillary wire 103 has a connecting section 103b extending between the end portion 103a (each end portion) and the multitude of turns wound on the support 104.

In the coil 1 said connecting section 103b extends away from the protrusion 52 and rests on the top face 51b of the edge 51a of the base 51.

As already stated, the connector 1, preferably obtained by means of cutting and bending a metal sheet, comprises an elastic clip contact element 2 shaped so as to engage with the terminal 50 and establish the electrical connection.

Preferably, the elastic clip contact element 2, in a section plane transverse to the main direction of the protrusion, is substantially C-shaped.

More precisely, the elastic clip contact element 2 comprises a base wall 2a from which two retaining tabs 2c extend transversely, said retaining tabs 2c being provided, respectively, with a first 6a and a second inner face 6b facing each other.

More in detail, extending orthogonally from the base wall 2a are two support arms 2b from which two bent and shaped retaining tabs 2c protrude and extend in planes orthogonal to the plane of the base wall 100a. In particular, the elastic clip contact element 2 is obtained by cutting and bending a metal sheet, in which the retaining tabs 2c lie in planes orthogonal to the plane in which the base wall 2a lies.

The conformation of the elastic clip contact element 2 permits the preloading of the retaining tabs 2c to ensure the closing of the elastic clip contact element 2 on the terminal 50 (in particular on the protrusion).

It is worth noting that, in one assembled configuration of the coil 1, the connector 1 is placed around the protrusion 52 of the terminal 50.

Thus, the base wall 2a faces a lateral flank 56c of the protrusion 52, whereas the two retaining tabs 2c (and the support arms 2b) extend away from the lateral edges of the base wall 2a respectively facing (and abutting on) the first planar face 56a and the second planar face 56b of the protrusion 52.

Therefore, in the preferred embodiment, the connector 1 is open along the main direction “A” of the protrusion (that is, not on top of it).

It is also worth noting that the longitudinal dimension of the base portion 2a is smaller than that of the arms 2b.

According to one aspect of the present invention, on at least one of the inner walls 6a there is at least one cutting element 3 for cutting the insulating layer of the capillary wire 103 wound on the terminal 50.

In particular, the cutting element 3 cuts the insulating layer of the capillary wire 103 and comes into contact with the inner conductive part (or core). The terminal 50 is thus placed in contact with the secondary winding 102 through the elastic clip contact element 2 of conductive material 1. The current thus flows in the winding 102 and through the cutting element 3 into the elastic clip contact element 2 which in turn is electrically in contact with the terminal 50 via the abutment body 5 thus closing the circuit.

Preferably, the cutting element 3 is only arranged on the first inner wall 6a.

More preferably, the first inner wall 6a is provided with a plurality of cutting elements 3 or blades. In particular, said cutting elements are longitudinal ribs obtained for example by means of a broaching process.

In the embodiment that is illustrated, the cutting elements 3 are defined by an array of blades 3a arranged side by side along a direction transverse to a direction of insertion on the terminal 50 of said connector 1.

The blades 3a in the array are parallel to one another and each extends parallel to said direction of insertion.

Thus, the array of blades 3a extends transversely to the main direction of the terminal 50 (in the assembled configuration), while each blade 3a extends parallel to it.

Preferably the cutting elements 3 are blades obtained by means of a broaching process which makes it possible to obtain extremely sharp profiles. However, the cutting elements may also be obtained by means of a deformation or milling process.

Preferably, the stop means 4 of the elastic clip contact element 2 are defined by at least a first projecting portion 7a and a second projecting portion 7b of the first 6a and second inner face 6b of the retaining tabs 2c.

The first 7a and the second projection portion 7b are at least partially opposite one another.

Preferably, in the closed position and in the absence of the terminal 50, the first 7a and the second projecting portion 7b come into contact with one another.

In use, i.e., in the assembled configuration, the first 7a and the second projection portion 7b come at least partly into contact with respective planar faces 56a, 56b of the protrusion 52 of the terminal 50.

The first projecting portion 7a protrudes more from the respective inner face (the first 6a) than said cutting element 3.

Thus, when the first projecting portion 7a is placed in contact with the protrusion 52 the cutting element 3 is always at a predetermined distance from it. Advantageously, in this way the cutting element 3 can never sever the capillary wire 103.

In the preferred embodiment, the distance between the top of the cutting element 3 (i.e., the blade) and the top of the first projecting portion 7a is such as to permit the penetration of hardly more than the insulating layer of the wire 103.

Thus, said distance is preferably less than the radius of the cross section of the capillary wire 103.

In a preferred embodiment, not illustrated, the first projecting portion 7a comprises at least one specific projection (or bulge) opposite to the second projecting portion 7b and arranged above the cutting element (i.e., distal to the base wall 2a with respect to the cutting element 3).

Preferably, in use, the first projecting portion 7a is arranged in correspondence with the second planar face 56b of the protrusion 52 of the terminal 50, preferably in correspondence with the third area 52c.

The second projecting portion 7b instead comprises at least one bulge 8 projecting from the second inner face 6b and placed in contact with the protrusion of the terminal 50 to establish the electrical connection.

Said bulge 8 defines the abutment body 5.

In the assembled configuration of the coil, said bulge 8 is therefore placed in contact with the third area 52c of the protrusion.

Said second inner face 6b further comprises a seat 9, adjacent to said bulge 8, facing said at least one cutting element 3.

Said seat 9 is sized to accommodate said non-cut portions of the contact portion 106b of the capillary wire 103, without damaging them.

The “non-cut” portions are thus those portions extending along the second planar face 56b of the protrusion 52 which continue, on the first planar face 56a, with the portions cut by the cutting element 3.

More preferably, the bulge 8 is interposed between two seats 9, one designed to accommodate the turns of the contact portion and one designed to accommodate the turns of the ligature portion of the capillary wire 103.

Preferably, the second projecting portion 7b also comprises a peripheral ring 10 at least partially surrounding and spaced from the bulge 8.

At least part of the space between the bulge 8 and the ring 10 defines said seat 9.

Preferably, the two bent and shaped retaining tabs 2c extend in planes orthogonal to the plane of the base wall 2a.

The conformation of the retaining tabs 2c is such as to permit the preloading of said tabs 2c, in order to ensure the closing of the elastic clip contact element 2 on the terminal 50.

Preferably, the retaining tabs 2c thus extend at least partly towards one another.

More precisely, the tabs 2c extend towards one another, each starting from the respective arm 2b, with respective first portions 13a converging and then continuing with respective second portions 13b substantially parallel to one another; the first 6a and the second inner face 6b are defined on the second portions 13b and correspond to the portion of the elastic clip contact element 2 that comes into contact with said terminal 50.

Furthermore, preferably, in the position distal to the arms 2b, the tabs 2c end with respective diverging third portions 13c.

In other words, each retaining tab 2c has a respective top portion 2d defined by the third portion 13c.

Preferably, the top portion 2d is provided with a recess 11 designed to accommodate an end of a connector insertion tool (described later on).

Preferably, the connector 1 further comprises an additional spring body 12 designed to be fitted over the elastic clip contact element 2.

The conformation of the additional spring body 12 is such that in the condition in which it is mounted over the elastic clip contact element 2 it has two tabs 12c opposite to and spaced apart from one another which extend from two base side walls 12a. The end portion of the tabs 12c is bent to impart an additional force in order to hold the elastic clip contact element 2 in the closed position, by acting on the tabs 2c. The retaining tabs 12c extend at least in part like the retaining tabs 2c of the elastic clip contact element 2. Thus, said retaining tabs 12c extend at least partly towards one another.

Preferably, said retaining tabs 12c have an angled end portion that abuts on the respective retaining tab 2c of the elastic clip contact element 2, in particular on an outer face thereof.

Furthermore, the spring body 12 comprises two bent portions 12b which form brackets that come into contact with and rest on the support arms 2b of the elastic clip contact element 2. Said brackets extend from a pair of base side walls 12a in the opposite direction to the two retaining tabs 12c.

It is worth noting that, preferably, the additional spring body 12 is made of a material with lower electrical conductivity but better mechanical properties than said elastic clip contact element 2.

Advantageously, this makes it possible to maintain a constant transverse contact force throughout the entire life of the coil 1 without affecting the quality of the electrical connection.

In the preferred embodiment, for example, the elastic clip contact element 2 is made of copper alloy (preferably CuNi3SiMg alloy) and said additional spring body 12 is made of stainless steel for springs.

During assembly, before being inserted on the terminal 50 of the coil 1, the connector 1 must be placed in the open position. This operation can be performed by hand or with the aid of a specific tool. It is important to place the elastic clip contact element 2 in the open position and keep it open until the end of the insertion, to prevent the cutting elements 3 from coming into contact with the turns of the capillary wire 103 during the insertion.

More precisely, the connector 1 is placed in a specific loading area, with the elastic clip contact element in the closed position.

Next, the elastic clip contact element 2 is switched from the closed position to the open position with the aid of a retractor tool 200.

The retractor tool 200 is thus designed to impart a transverse force on the retaining tabs 2c (and the retaining tabs 12c) to push them apart.

In the preferred embodiment, the retractor tool 200 acts in correspondence with the undercuts defined by the recesses formed in the top portion of each retaining tab 2c.

More precisely, the retractor tool 200 comprises a gripper 200a provided with a pair of shaped arms 200b that can be moved away from one another and are provided with an end portion 200c that can be inserted in said undercut (or recess 11).

Preferably, the arms 200b of the gripper 200a are hinged at a pivot point; the gripper 200 is thus preferably configured as a double lever of the first order.

In the preferred embodiment, there is also a step of circumferential (i.e., peripheral) retention of the connector 1.

Advantageously, said retention action combined with the lateral pushing action (i.e., opening) of the elastic clip contact element 2 ensures that the connector 1 remains attached to the tool.

Thus, preferably, a sleeve 201 provided with a cavity 201a shaped to fit around said connector 1 is lowered over said connector to accommodate it.

The retractor tool 200 is preferably able to slide axially inside the sleeve to reach the retaining tabs 2c of the elastic clip contact element 2 once the sleeve 201 has been placed around the connector 1.

Thus, the arms 200b inserted in the cavities of the retaining tabs 2c ensure that the connector is held in suspension and then moved towards the second winding 102.

Preferably, the handling equipment further comprises a fork or safety tab configured to act with the retractor tool 200 to support the elastic clip contact element 2 to ensure correct gripping by said retractor tool 200.

Furthermore, the fork or tab is preferably configured to press on the additional spring element to hold it in place with respect to the elastic clip contact element 2 to guarantee the stability of the coupling.

Downstream of said handling step there is also a step of coupling the connector 1 to the terminal 50.

Said coupling is performed by lowering the connector 1 with the elastic clip contact element 2 in the open position, onto said terminal 50.

In particular, the elastic clip contact element 2 is lowered along the protrusion 52 of the terminal 50.

Thus, this step is performed by means of a translation movement along the main direction of the protrusion 52.

Lastly, the process envisages the actual connection by releasing the retaining tabs 2c, so as to allow them to move (independently and elastically) from the open position to the closed position.

Therefore, after the insertion, the arms 200b of the retractor tool are extracted from the connector 1, whereas the casing 200a continues to press vertically on the connector 1 to ensure that it rests properly on the support 104. In this step the elastic clip contact element 2 moves from the open position to the closed position.

Thus, advantageously, the connector is coupled extremely easily and rapidly, without any risk of severing or damaging the capillary wire 103.

Of course, without prejudice to the principle of the invention, the construction details and embodiments may vary widely with respect to that described and illustrated herein purely by way of example, without departing from the scope of the present invention.

1. A connector for electrical connection to an ignition coil in an ignition system of an internal combustion engine comprising a terminal on which is wound an end portion of a capillary wire covered by an insulating layer,
said connector comprising an elastic clip contact element of conductive material which can be fitted on said terminal and which is movable between an open position and a closed position, said elastic clip contact element in a rest condition tending to return to the closed position, wherein said elastic clip contact element is provided with:
at least one cutting element on at least one inner wall for engraving said capillary wire insulating layer wound on the terminal,
stop means which prevent the elastic clip contact element from closing beyond a determined amount or entity, wherein in said closed position said elastic clip contact element has a mechanical retention function and, at the same time, it creates an electrical contact between the terminal and the capillary wired.

2. The connector according to claim 1, wherein said elastic clip contact element comprises a base wall from which two retaining tabs transversally extend, wherein the retaining tabs are provided respectively with a first and a second inner face facing each other; said at least one cutting element being formed on said first inner face.

3. The connector according to claim 2, wherein said first inner face is provided with a plurality of cutting elements defined by an array of blades placed side by side along a direction transverse to a direction of insertion of said elastic clip contact element on the terminal.

4. The connector according to claim 3, in which said blades are parallel to each other and extend each parallel to said direction of insertion.

5. The connector according to claim 1, wherein said elastic clip contact element comprises a base wall from which extend substantially orthogonally two support arms from which said bent and shaped retaining tabs protrude and extend in planes orthogonal to the plane of the base wall, wherein the conformation of said retaining tabs is such as to permit preloading of said tabs to ensure the closing of the elastic clip contact element on the terminals.

6. The connector according to claim 5, wherein said retaining tabs extend at least partly towards each other and have respectively a first and a second inner face facing each other and defining the portion that comes into contact with said terminal.

7. The connector according to claim 1, wherein the stop means of said elastic clip contact element are defined by at least a first projecting portion and a second projecting portion of the first and second inner face of the retaining tabs.

8. The connector according to claim 7, wherein the first projecting portion protrudes more from the respective inner face than said cutting element.

9. The connector according to claim 7, wherein the second projecting portion comprises at least one bulge projecting from the second inner face and, in use, placed in contact with a protrusion of the terminal to establish the electrical connection.

10. The connector according to claim 7, wherein said second inner face further comprises a housing, facing said at least one cutting element and sized to accommodate, without damaging them, those non engraved portions of the capillary wire.

11. The connector according to claim 1, wherein said connector, before being inserted on the terminal, is maintained in the open position either manually or with the aid of a suitable retractor tool which brings the elastic clip contact element to the open position and keeps it open until the end of the insertion, so as to prevent said cutting elements from coming into contact with the capillary wire during the insertion.

12. The connector according to claim 11, wherein said elastic clip contact element comprises a base wall from which two retaining tabs transversally extend, wherein the retaining tabs are provided respectively with a first and a second inner face facing each other; said inner faces (6a, 6b) each comprising a respective top portion provided with a recess designed to receive one end of said retractor tool.

13. The connector according to claim 1, comprising an additional spring body designed to be fitted over the elastic clip contact element, having a conformation such that in the mounted condition over said elastic clip contact element it has two retaining tabs opposite and spaced from one another, whose end portion is folded to impart a further force suitable to keep the elastic clip contact element in the closed position, acting on the retaining tabs of said elastic clip contact element.

14. The connector according to claim 13, wherein said additional spring body is made of a material having mechanical and electrical properties different from said elastic clip contact element.

15. The connector according to claim 13, wherein said elastic clip contact element is made of copper alloy and said spring body is made of stainless steel.

16. A terminal for a capillary wire winding of an ignition coil for internal combustion engines, comprising:
a base that can be plugged into a plastic casing on which said capillary winding is wound;
a protrusion extending along a main direction thereof away from the base and provided with:
at least a first, ligature, area, configured to allow a solderless fixation of the capillary wire,
at least a second, contact, area, designed to receive a plurality of adjacent turns of said capillary wired.

17. The terminal according to claim 16, wherein the first area is distal to the base with respect to the second area.

18. The terminal according to claim 16, wherein said first area and said second area are arranged in succession along a main direction of the protrusion, wherein the first area extends between an end distal to and an end proximal to the second area; said end proximal to the second area being at least partly defined by at least one wire retaining shoulder extending transversely to the main direction to prevent the sliding of the wire towards the second area.

19. The terminal according to claim 16, wherein said first area and said second area are arranged in succession along the main direction of the protrusion, wherein the second area has at least one end proximal to the first area defined by at least one wire retaining shoulder extending transversely thereto to prevent the sliding of the wire towards the first area.

20. The terminal according to claim 16, wherein said protrusion further comprises a third area sufficiently big to allow an abutment of an abutment body of a connector.

21. The terminal according to claim 20, wherein the third area is interposed between the first area and the second area and has at least one face, which in use is free from the presence of the capillary wire.

22. The terminal according to claim 16, wherein said protrusion has at least a first and a second planar face opposite one another and connected by two lateral flanks, wherein said second area is defined on said first planar face.

23. The terminal according to claim 16, wherein said protrusion has at least a first transverse groove formed in at least one of its lateral flanks and delimiting at least part of the first area.

24. The terminal according to claim 23, wherein said first transverse groove is delimited by two ramps opposite one another and spaced apart, which define respective shoulders for holding the capillary wire.

25. The terminal according to claim 16, wherein said protrusion has at least a second transverse groove formed in one of its lateral flanks and delimiting at least part of the second area.

26. The terminal according to claim 25, wherein said second transverse groove is formed in an area of intersection between the protrusion and the base.

27. The terminal according to claim 26, wherein said second transverse groove is delimited by a first edge, proximal to the first area and adjacent to the protrusion, and by a second edge, distal to the first area and adjacent to the base.

28. The terminal according to claim 27, wherein said first and said second edge of the second groove are oriented transversely, preferably orthogonally, to one another.

29. The terminal according to claim 16, wherein said base has an edge extending laterally to said protrusion and provided with at least a top face extending in a plane transverse to a direction of extension of said protrusion to define a supporting surface for a capillary wire portion extending from said second area.

30. An ignition coil for an ignition system of an internal combustion engine, comprising:
a primary winding that can be connected, by means of an electrical connection, to a generator;
a secondary winding that can be connected to a spark plug and provided with a multitude of turns of capillary wire covered with an insulating layer and wound on an electrically insulating support;
wherein said support comprises at least one receiving seat in which there is inserted a terminal to which an end portion of the capillary wire is anchored;
and in that it comprises a connector provided with an elastic clip contact element fitted on said terminal and provided with:
at least one cutting element for engraving said capillary wire insulating layer, stop means to prevent the elastic clip contact element from closing beyond a determined amount or entity and
an abutment body that comes into contact with the terminal to create the electrical connection between said capillary wire and said terminal.

31. The ignition coil according to claim 30, wherein said capillary wire has at least an end portion provided with a ligature portion anchored without welding to said first area of the protrusion of the terminal.

32. The ignition coil according to claim 31, wherein said ligature portion of the end portion of the capillary wire has at least two turns partly knotted to each other in order to fix the capillary wire to the terminal without welding.

33. The ignition coil according to claim 31; said end portion of the capillary wire being further provided with a contact portion wound on said second area of the protrusion of the terminal so as to define a plurality of adjacent turns placed side by side.

34. The ignition coil according to claim 33, wherein said capillary wire further comprises a connecting section between said end portion and said multitude of turns wound on the support, wherein the connecting portion extends away from said protrusion and rests on a top face of the edge of the base of a terminal.

35. The ignition coil according to claim 30, wherein said protrusion of the terminal extends along a main direction thereof substantially orthogonal to a support surface of said terminal in the receiving seat.

36. The ignition coil according to claim 30, wherein said receiving seat of the support comprises a cavity substantially counter-shaped with respect to a profile of the base of the terminal and equipped with a plurality of friction protrusions suitable to hold said terminal in place.

37. The ignition coil according to claim 30, wherein said capillary wire of the secondary winding has a first (103a′) and a second end portion (103a″) each associated with a respective first or second terminal and with a respective first or second connector.

38. The ignition coil according to claim 37, wherein said first terminal is connected to ground and said second terminal is connected, via a connecting element, to a spark plug.

39. (canceled)

40. A fitting process for the engagement of a connector according to claim 1, wherein it comprises the following steps:
preparation of a connector in a loading zone; said connector having the elastic clip contact element in the closed position;
peripheral retention of said connector by means of a sleeve provided with a cavity shaped to fit around said connector;
switching of the elastic clip contact element from the closed position to the open position by means of transverse thrust action on the retaining tabs to space them away from each other, performed by a retractor tool;
retention of the retaining tabs of the elastic clip contact element in suspension;
handling of the connector from said loading area to an assembly area.

41. The fitting process according to claim 40, wherein the inner faces of the retaining tabs of the elastic clip contact element each comprise a respective top portion provided with a recess defining an undercut; said switching and retention steps of the retaining tabs being carried out by coupling said retractor tool to said recess.

42. The fitting process according to claim 41, wherein the tool retractor comprises a gripper provided with a pair of shaped arms movable away from each other and provided with an end portion that can be inserted in said recess.

43. The process according to claim 40, comprising, downstream of said handling step, a step of coupling the connector plug in a terminal; said coupling step being performed by lowering said connector with the elastic clip contact element in the open position along said protrusion of the terminal.

44. The fitting process according to claim 40, further comprising a step of connecting said connector to said terminal performed by extracting said retractor tool from the connector and allowing the elastic clip contact element to move from the open position to the closed position.
